(19) United States
(12) Patent Application Publication
(10) Pub. No.: US 2015/0088284 A1
(43) Pub. Date: Mar. 26, 2015

(54) Miniature Surface EMG/EKG

(71) Applicant: Board of Trustees of The University of Alabama, Tuscaloosa, AL (US)

(72) Inventors: Brandt David Hendricks, Jay, FL (US); Patrick Royce LeClair, Tuscaloosa, AL (US); Jacob Fondriest, Granville, OH (US); Danny Whitcomb, Northport, AL (US); Jason Kuykendall, McCalla, AL (US)

(21) Appl. No.: 14/496,663

(22) Filed: Sep. 25, 2014

Related U.S. Application Data
(60) Provisional application No. 61/882,215, filed on Sep. 25, 2013.

(51) Int. Cl. G06F 3/01; G05B 19/042

(52) U.S. Cl. CPC G06F 3/015; G05B 19/0423; G05B 2219/21002
USPC 700/83

(57) ABSTRACT

This invention relates to biofeedback device, and more particularly to device for detecting, interpreting and recording the electrical field generated by the contraction of muscles and using the electrical field data to control an external device.

### CROSS REFERENCE TO RELATED APPLICATIONS

This application claims the benefit of priority to U.S. Provisional Patent Application No. 61/882,215, filed Sep. 25, 2013, which is incorporated herein by reference in its entirety.

### TECHNICAL FIELD

This invention relates to biofeedback device, and more particularly to device for detecting, interpreting and recording the electrical field generated by the contraction of muscles and using the electrical field data to control an external device.

### BACKGROUND

An electrocardiogram (EKG) system is used to monitor heart electrical activity in a patient. Similar in function, electromyogram (EMG) systems are used to measure the electrical impulses of muscles at rest and during contraction. Conventional EKG and EMG systems are cumbersome and do not provide an opportunity to measure both EKG and EMG signals to provide an output that is both meaningful and useful. Moreover, conventional systems require separate hardware/software for the measurement and processing of EKG and EMG signals. While some devices boast compatibility with either system, each requires the purchase of additional and costly equipment to integrate both EKG and EMG systems together. Therefore, there is a need in the art for an integrated EKG/EMG system.

### SUMMARY

Presented are systems and methods using a biofeedback device for detecting, interpreting and recording the electrical field generated by the contraction of muscles and using the electrical field data to control an external device. An aspect of the present invention is directed to biofeedback device for processing an electrical signal generated by with the contraction of one or more muscles. The device may include a processor in electrical communication with a sensor worn by a user. The processor may include a signal processing circuit for processing at least at least one of an electrocardiogram (EKG) signal and an electromyogram (EMG) signal received from the sensor and a selector switch for changing an amplification factor of the signal processing circuit. The device may further include a microcontroller for receiving the processed signal from the processor. The microcontroller may provide an output signal to an external device, where the output signal provides instructions for controlling at least one function of the external device.

Another aspect of the present invention is directed to a method of using a biofeedback device for directing the control of an external device. The method may include receiving an input signal at the device from a sensor coupled to a user's skin. The input signal may include at least one of an electrocardiogram (EKG) signal and an electromyogram (EMG) signal. The method may further include processing the input signal at a signal processing circuit included in the device such that processing the signal may include applying an amplification and a filter to the input signal. The method may further include receiving the processing signal at a controller and providing an output signal to the external device based on the processed signal. The output signal may include instructions to the external device for controlling at least one function of the external device.

The details of one or more embodiments of the invention are set forth in the accompanying drawings and the description below. Other features, objects, and advantages of the invention will be apparent from the description and drawings, and from the claims.

### DESCRIPTION OF DRAWINGS

The device is explained in even greater detail in the following drawings. The drawings are merely examples to illustrate the structure of preferred devices and certain features that may be used singularly or in combination with other features. The invention should not be limited to the examples shown.

FIG. 1A is a schematic diagram of an example biofeedback device;

FIG. 1B is a schematic diagram of an example biofeedback device;

FIG. 2 is provides an illustration of an example biofeedback device;

FIG. 3 provides an example EMG signal;

FIG. 4A provides an example visual display of an EKG signal;

FIG. 4B provides an example visual display of an EMG signal;

FIG. 5 provides an illustration of an example sensor and associated decomposition of the biosignal;

FIG. 6A is an example processing circuit;

FIG. 6B is the processing circuit of FIG. 6A;

FIG. 6C is an example of an other processing circuit; and

FIG. 6D is the processing circuit of FIG. 6C.

Like reference symbols in the various drawings indicate like elements.

### DETAILED DESCRIPTION

Certain terminology is used in the following description for convenience only and is not limiting. The words “right”, “left”, “lower”, and “upper” designate direction in the drawings to which reference is made. The words “inner”, “outer” refer to directions toward and away from, respectively, the geometric center of the described feature or device. The words “distal” and “proximal” refer to directions taken in context of the item described and, with regard to the instruments herein described, are typically based on the perspective of the surgeon using such instruments. The terminology includes the above-listed words, derivatives thereof, and words of similar import.

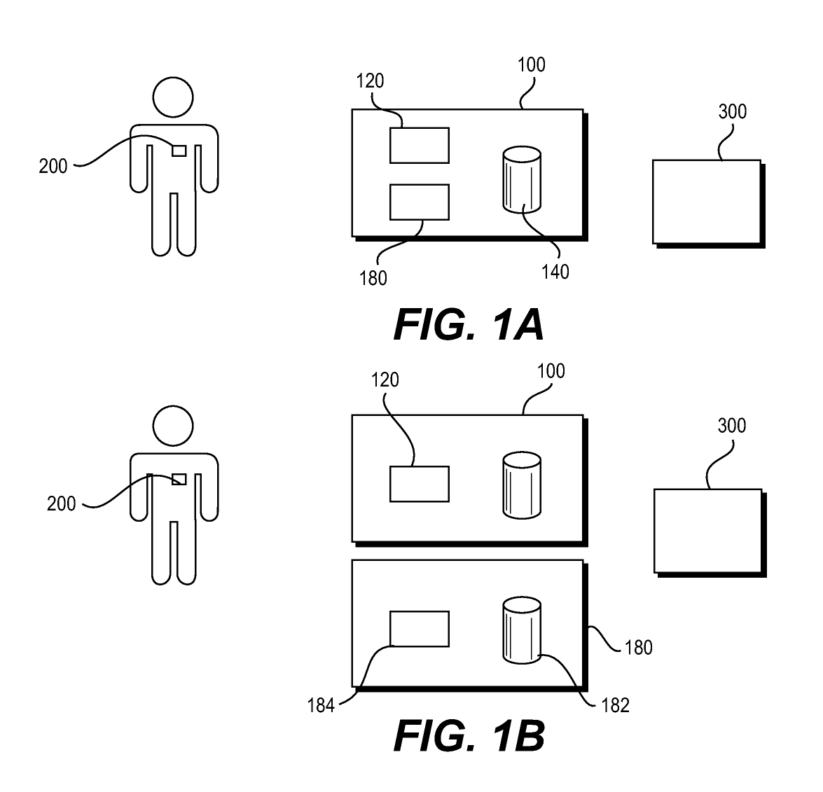

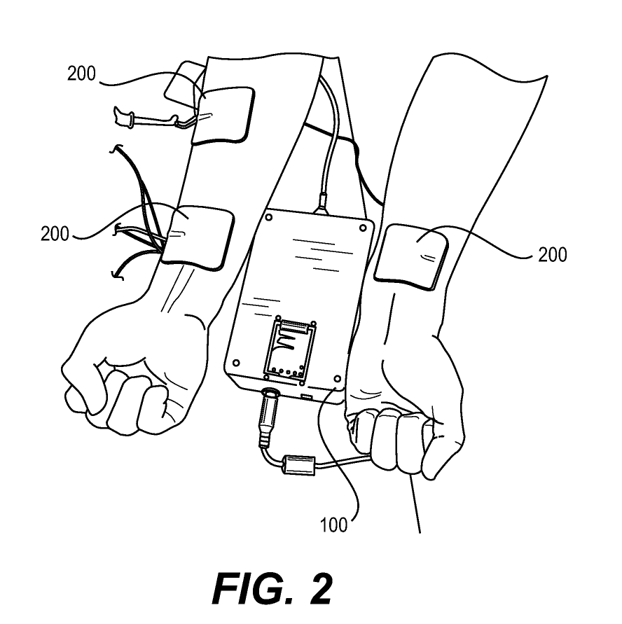

Certain examples of the invention will now be described with reference to the drawings. In general, such embodiments relate to a biofeedback device for detecting, interpreting and recording the electrical field generated by the contraction of muscles and using the electrical field data to control an external device. FIGS. 1A includes a schematic diagram of an example biofeedback device 100. As illustrated in FIG. 2, the biofeedback device 100 may be in communication with a sensor 200 worn by a user. Using the signal received from the sensor 200, the biofeedback device 100 processes the signal and provides instructions for controlling the function of an external device 300.

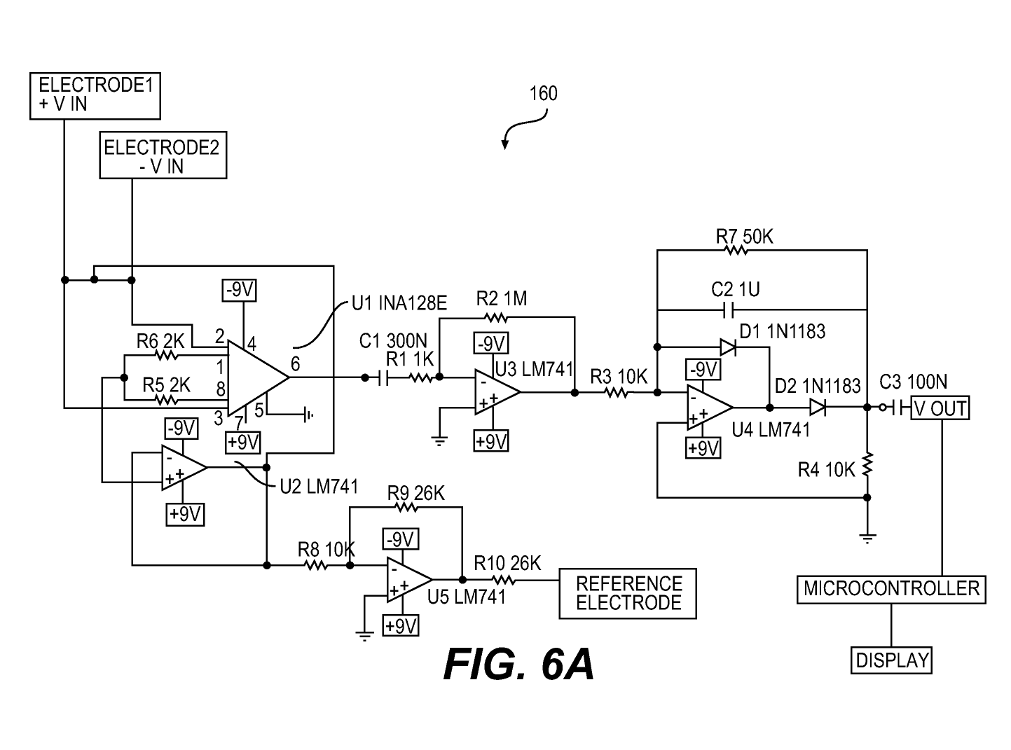

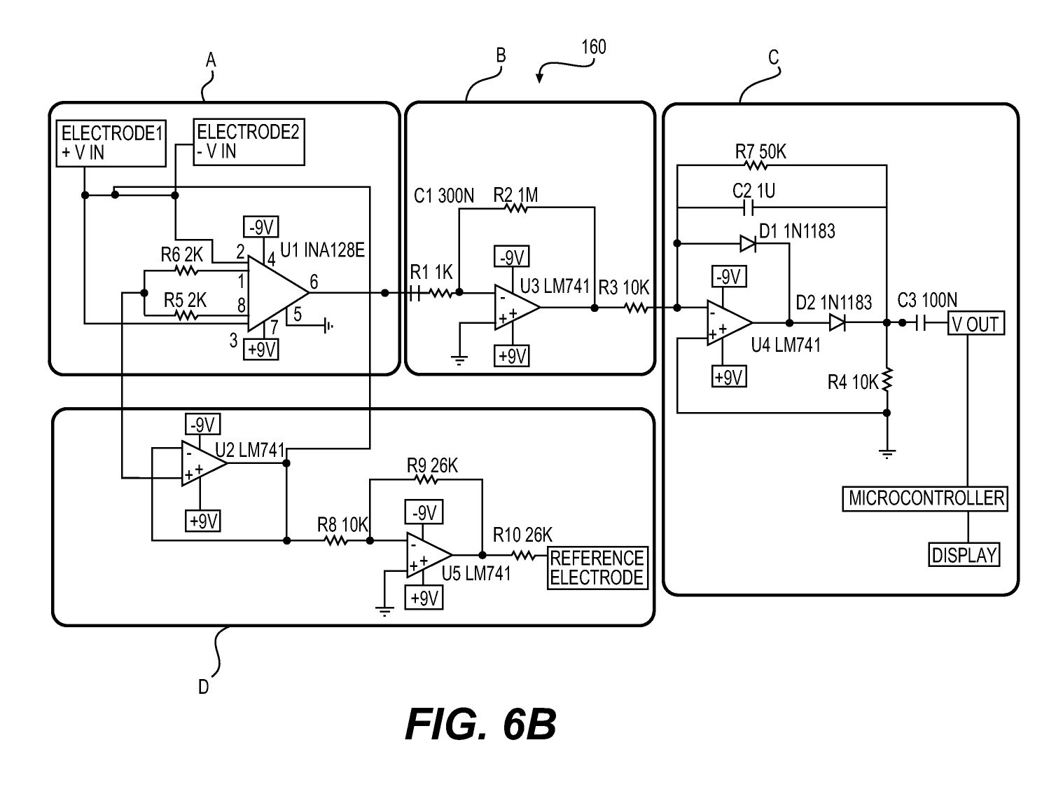

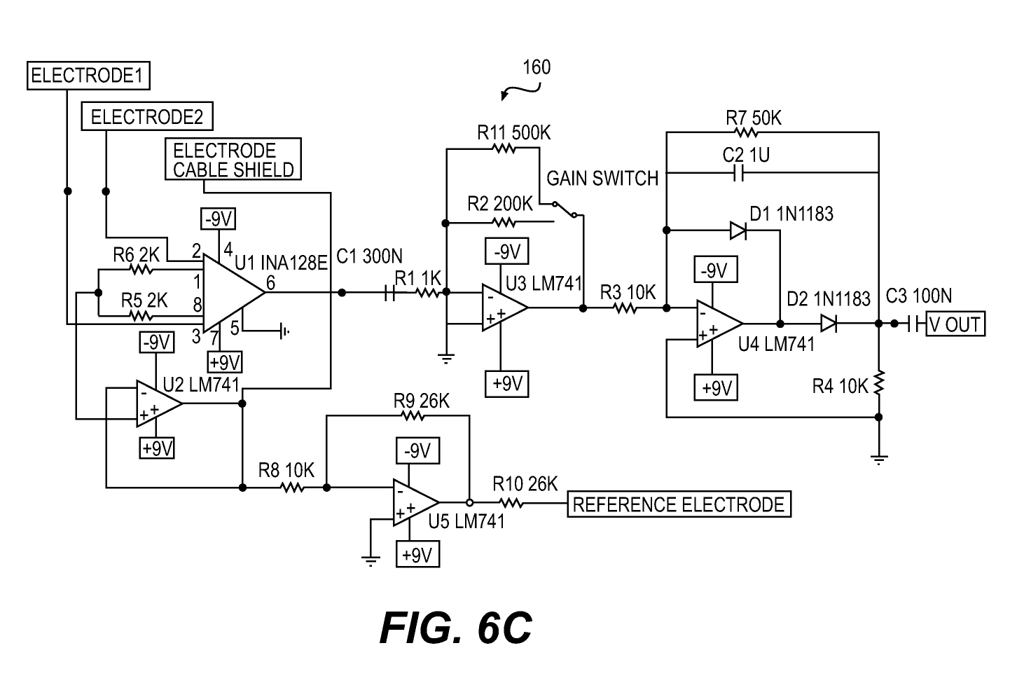

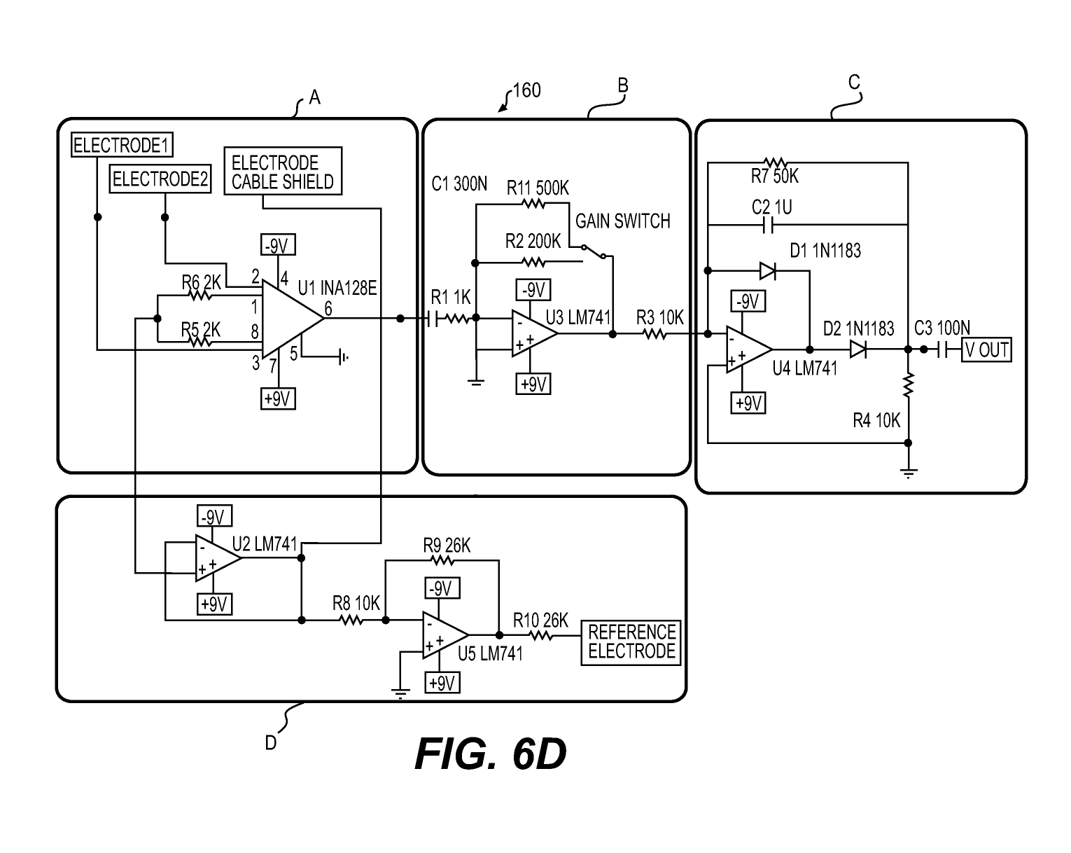

An example biofeedback device 100 can include at least one processor 120 and a system memory 140. Depending on the exact configuration and type of computing device, system memory 140 may be volatile (such as random access memory (RAM)), non-volatile (such as read-only memory (ROM), flash memory, etc.), or some combination of the two. The processor 120 may be a standard programmable processor that performs arithmetic and logic operations necessary for operation of the biofeedback device 100. The processor 120 may be in electrical communication with the sensor 200 and receive the output signal of the sensor 200. The processor 120 may include signal processing circuit 160 for processing the signal received from the sensor 200. As will be described with respect to FIGS. 6A and 6B, the signal processing circuit 160 can amplify and filter the signal received from the sensor 200 for use by a control unit 180. The processor 120 can further include a selector switch for changing an amplification factor of the signal processing circuit 160. The biofeedback device 100 may include a bus or other communication mechanism for communicating information among various components of the biofeedback device 100 and/or control unit 180.

It is contemplated that the processor can receive and process both electrocardiogram (EKG) signal and an electromyogram (EMG) signals. It is also contemplated that multiple sensors 200 may be used and each of the sensors 200 may provide their output signals to the processor 120. Accordingly, an example biofeedback device 100 can receive multiple EKG and/or EMG signals from multiple sensors 200 coupled to the same user for processing.

As illustrated in FIG. 1A, the biofeedback device 100 may also include a control unit 180 for receiving and processing the signal received from the processor 120. An example control unit 180 can include a microcontroller. The control unit 180 can include a single-board microcontroller such as, for example, an Arduino microcontroller. The control unit 180 can be capable of being reprogrammed by the user. For example control unit 180 can have a programming language/logic, using the programming language the user can customize actions/instructions performed by the control unit 180 upon receiving biosignals sensor 200. Likewise, using the programming language, the user can customize the properties of the biosignals the control unit 180 will or will not act upon. For example, if the user wants the control unit 180 to perform an action when a signal is only above a certain threshold magnitude, corresponding program instructions/logic can be provided to the control unit 180.

As illustrated in FIG. 1A, the control unit 180 can be integral to the biofeedback device 100. In another example, illustrated in FIG. 1B, the control unit 180 is not integral to the biofeedback device 100. For example, the control unit 180 may be separate from the biofeedback device 100 and can include its own system memory 182 and processor 184 for performing arithmetic and logic operations necessary for operation of the control unit 180. Whether integral or independent of the biofeedback device 100, the control unit 180 can be in wired or wireless communication with the processor 120.

The control unit 180 processes the signal received from the processor 120 to generate an output signal to an external device 300. The output signal can provide instructions for controlling at least one function of the external device 300. The output signal can provide instructions for controlling at least one pre-programmed function of the external device 300. In an example control unit 180, the output signal is provided to the external device 300 when the output signal from the processing circuit 160 reaches a predetermined threshold. The voltage level of the predetermined threshold is determined based on the amount of amplification in the processing circuit 160 as well as the user's individual characteristics (e.g., type and placement of sensor 200, user's fat content, sweat or other conductive material present on the user's skin, and the size of the muscle group being measured). The predetermined threshold can include a range of threshold values correlated to the individual user/wearer of sensor 200. The control unit 180 may allow the user to change the predetermined threshold value.

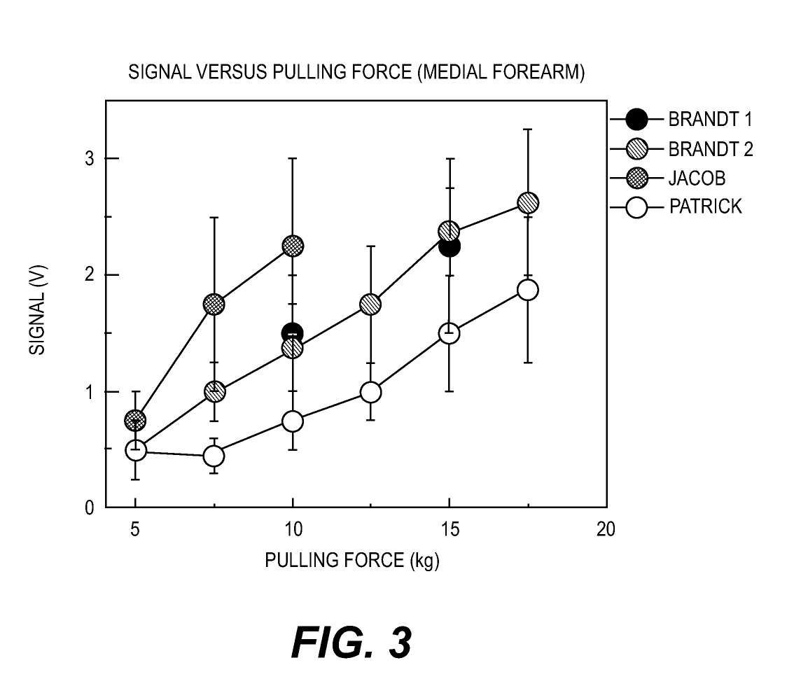

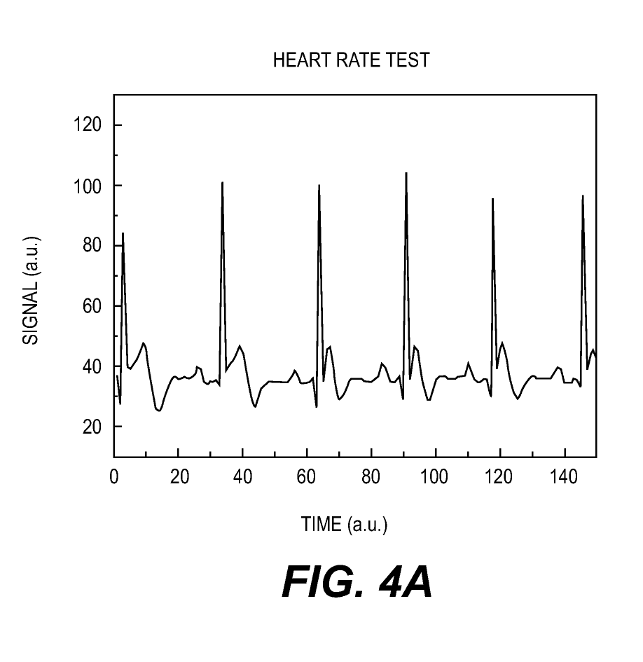

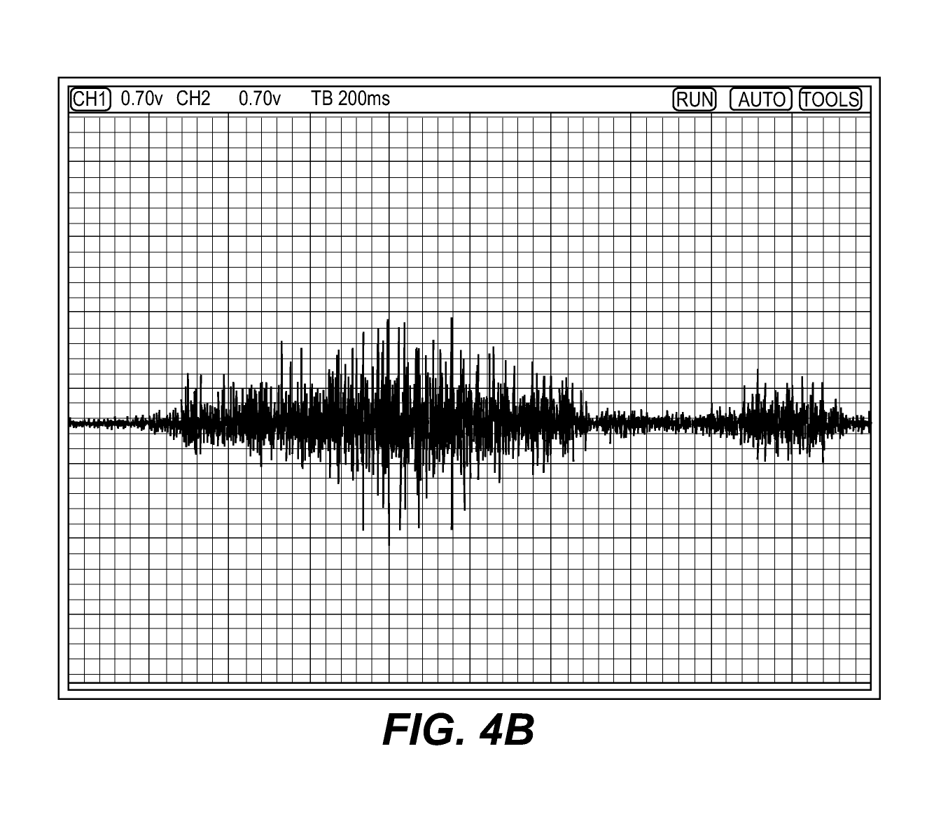

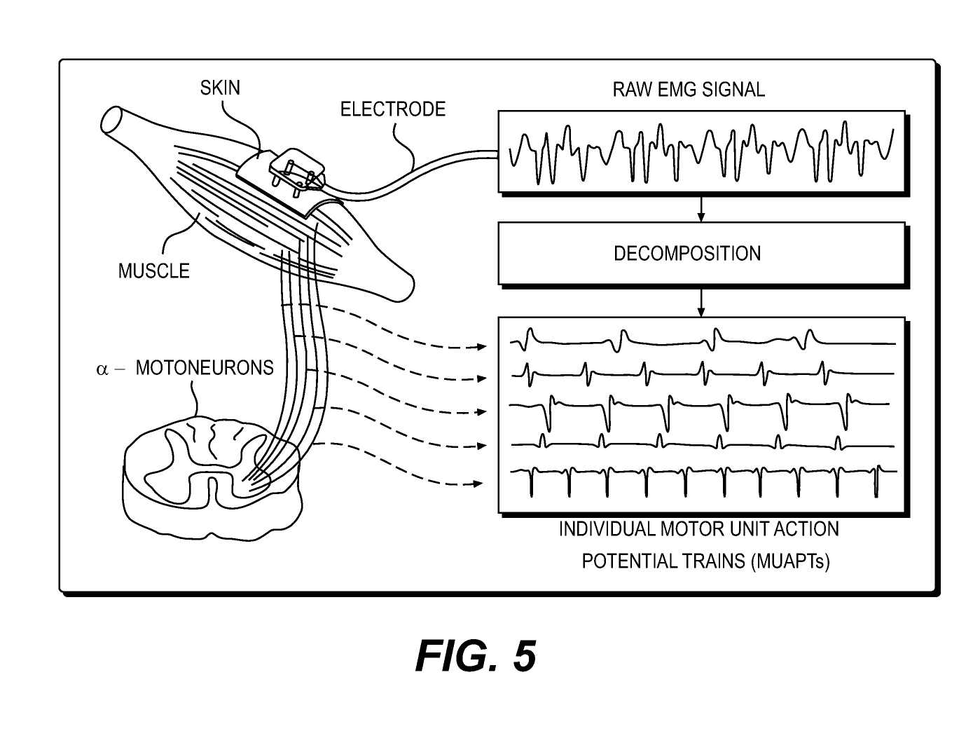

An example external device 300 can include a visual display unit. For example, the external device 300 can include a display screen, such as an LCD display/monitor, smartphone, tablet or any other type of display/display screen known in the art. The visual display unit can be integral to or separate from the biofeedback device 100. The visual display unit can provide a visual representation of the electrical activity of skeletal and cardiac muscle contractions corresponding to the input signal received from the sensors 200. An example, visual display unit can provide instant visual feedback such as a linearly scaled graph of voltage with respect to time. FIG. 3 provides an example graphed EMG signal received from the sensor 200. FIG. 3 illustrates compiled signal data from several measurements. For example, the compiled signal data can illustrate the average measured signal over several trials at different pulling forces. Using the compiled signal data, the user can verify that the signal correlates with the amount of force used/exerted by the wearer of the sensor 200. FIG. 4A provides an example visual display corresponding to an EKG signal received from the sensor 200. FIG. 4B provides an example visual display corresponding to an EMG signal received from the sensor 200. As illustrated in FIGS. 4A and 4B, the visual display can illustrate raw sensor data. This raw signal data can represent the output to the device 100. In another example, the visual display can provide a filtered or otherwise processed representation of the raw signal data.

The external device 300 can also include an audio source. For example, the external device 300 can include a speaker or some other device (integral to or independent from the biofeedback device 100) capable of creating a sound audible to the user in response to instructions received from the control unit 180. In an example device 100, the audio source can provide an audible signal to the user to indicate that the muscle corresponding to the sensor 200 is contracted and/or relaxed. In another example, the device 100 can be utilized in conjunction with an audio source-type external device 300 to indicate when the signal reaches a certain threshold level. For example, the external device 300 can emit a tone when the too much and/or too little force is being applied. In a further example, the device 100 can be utilized in conjunction with an audio source-type external device 300 to facilitate a communicating from users with a speech disability/impediment. In another example, the external device 300 can include a light source (integral to or independent from the biofeedback device 100). For example the light source can include an LED capable of producing a visible light in response to instructions received from the control unit 180.

The external device 300 can also include a motorized device (integral to or independent from the biofeedback device 100). Example motorized devices can be used in robotics, disability assistance (limbs and motorized vehicles), fitness/physical therapy, recreational use and military. Example motorized devices include a haptic device, a prosthetic limb, manned or unmanned motorized vehicles (wheelchair, scooter, car, airplane, boat, etc.), robot/robotic system, a remote control, and/or a radio transmitter. Example fitness/physical therapy uses can include utilizing the device 100, sensor 200, and control unit 180 to monitor and record the electrical activity of muscles during a workout/therapy or in planning a workout/therapy routine. The device 100 and control unit 180 can provide the user with real-time feedback as to performance and which muscles are being utilized and to what degree. Example military uses can include utilizing the device 100, sensor and/or control unit 180 to monitor muscle or cardiac electrical activity. An example remote control can include utilizing the device 100 to control a remote external device 300. It is contemplated that control of the remote external device 300 would include communication between the control unit 180/processor 120 and the remote external device 300. Example communication methods can include infrared (IR), radio-frequency identification (RFID), near field communication (NFC), radio signal, or any other wired or wireless communication signal/network. Once a method of communication is established the output of the control unit 180/processing circuit 160 can be used as a threshold value that once crossed can trigger a command to the remote external device 300.

It is contemplated that the external device 300 can include several external devices 300 used in conjunction with the biofeedback device 100 simultaneously. For example, an example system may include a visual display unit, an audio source, a light source and a motorized device, or any combination thereof, used at the same time with the biofeedback device 100.

As outlined above, the biofeedback device 100 is in electrical communication with a sensor 200 worn by a user. The sensor 200 may be in wired or wireless communication with the biofeedback device 100 and can be used to detect an EKG signal and/or EMG signal. This signal data is received from the sensor 200 which detects an electrical field generated by the contraction of muscles proximate the sensor 200 and provides a corresponding signal to the biofeedback device 100. The sensor 200 can include an electrode for measuring the electrical signal/field from the area of skin proximate to the sensor 200 when worn by the user. The sensor 200 can be adhered to the user's skin at a predetermined location for detecting small voltages associated with skeletal and cardiac muscle contraction proximate that predetermined location. FIG. 5 provides a schematic illustration of an example sensor 200 coupled to a user's skin for measuring an electrical signal/field associated with contracting of a corresponding muscle/muscle group. The raw signal data can be decomposed using the biofeedback device 100 into its constituent motor unit action potentials and recorded over time to generate a motor unit action potential train (MUAPT).

Depending on the intended muscle group to be measured (skeletal, cardiac) the sensor 200 is located at various locations on the user's body. For example, a sensor 200 associated with an EKG signal may be placed on the user's torso to detect contraction of the user's heart muscles. A sensor 200 associated with an EMG signal may be placed on the user's forearm or proximate a relevant muscle group. The signal provided by the sensor 200 to the control unit 180 can have a voltage corresponding to about the resting potential of muscle cells. For example, the signal provided by the sensor 200 to the control unit can have a voltage of about 1 mV. In another example, the signal provided by the sensor 200 to the control unit can have a voltage less than 1 mV. The value of the voltage provided by the sensor can vary based on the user's individual characteristics (e.g., type and placement of sensor 200, user's fat content, sweat or other conductive material present on the user's skin, and the size of the muscle group being measured, etc.).

It is contemplated that the system may include a plurality of sensors 200 coupled to the user. The processor 120, in electrical communication with each of the plurality of sensors 200, receives and process the plurality of signals, and then provides the signals to the control unit 180 for generating an instruction signal/plurality instruction signals to the external device 300. As outlined above, it is contemplated that the system will include both EKG and EMG sensors 200 simultaneously.

The biofeedback device 100 may be compact and portable. For example the biofeedback device 100 may be about 6-inches by about 3-inches in size. Further miniaturization of the biofeedback device 100 is contemplated. The biofeedback device 100 may be powered by an external or internal power source. For example the biofeedback device 100 may include a battery integral/coupled to the biofeedback device 100. An example integral power source can include a 9-volt battery, or any other replaceable or rechargeable power source. When used with a portable power source, such as a battery, it is contemplated that the function of the biofeedback device 100 may be streamlined so as to provide prolonged use. For example, the biofeedback device 100 may provide about 100 hours of continuous use. In another example, where the biofeedback device 100 includes an integrated visual display unit, the biofeedback device 100 may provide 10-12 hours of continuous use.

As outlined above, the biofeedback device 100 includes a signal processing circuit 160. As illustrated in FIG. 6A, the signal processing circuit 160 includes a plurality of amplification and filtering components. Highlighted in FIG. 6B, the signal processing circuit 160 includes an initial amplification (A), a second amplification and initial filtering (B), a final amplification and a final filtering (C), and a reference potential (D).

Referring to FIG. 6B, stage (A), the initial amplification, provides initial amplification and noise reduction. The stage (A) utilizes a precision, low-power differential amplifier (for example, INA128) whose amplification can be set with resistors. The amplifier can provide noise and common mode rejection as well as the ability to integrate a reference electrode. The initial amplification (A) can be utilized to reduce the number of components needed while improving the signal-to-noise ratio. Stage (A) can also provide a signal reference channel. The initial amplification provided in stage (A) is preferred to using a standard operational amplifier chips because the use of a precision differential amplifier, such as those included in the initial amplification (A), provide improved signal quality.

The stage (B), second amplification and initial filtering, can include a high-pass filter (the capacitor and resistor between stage (A) and stage (B)) to reduce noise and eliminate any constant (DC) voltages that made it through the stage (A) initial amplification. By eliminating the constant (DC) voltages, the second amplification and initial filtering provided in stage (B) can mitigate the possibility electric shock to the user, and avoid saturating the subsequent amplifier stages with unwanted DC signals. As outlined below, the selector switch can be included in stage (B). The selector switch can be used to change the overall circuit gain by altering the value of R2 (gains from 200-1000).

Stage (C), final amplification and a final filtering, can simultaneously amplify the signal while acting as a low-pass filter to “smooth” the signal. The signal is smoothed using the capacitor C2 in the feedback path combined with the high pass filter in stage (B). The resulting combination acts as a band-pass filter. In an example processing circuit 160, the final amplification can amplify the signal more than about four times. In another example, the signal is amplified about 5 times. In stage (C) the filter can include active filtering (i.e., in the feedback loop of the amplifier). In contrast, in stage (B) the filter can be purely passive. Stage (C) can also include diodes to preferentially amplify only the positive portion of the signal to further reduce noise. The output of stage (C) can also include a final capacitor to ensure that no constant (DC) voltages make it to the microcontroller or display stage. The final capacitor can also ensure that no DC voltages could propagate back to the user (preventing shock to the user).

Stage (D), reference potential, monitors the third (reference) electrode to ensure an acceptable signal-to-noise level. The human body's overall electrical potential can vary significantly even from just absorbing the 60 Hz electromagnetic radiation emanating from surrounding electrical power. Stage (D) can be used to monitor the user's body potential in real time. This potential is buffered, amplified, and used it as a reference (zero point or local ground connection) for the initial amplification stage (A). By monitoring the user's body potential and using it as the reference potential in stage (A) ensures that the device 100/processing circuit 160 measures only the potential difference resulting from muscle contraction and not variations in body potential due to the user's environment.

As provided above, the stages of the processing circuit 160 can utilize various types of filters and amplification. For example, stage (B) can utilize a passive RC high-pass filter for blocking constant voltages and slow variations in body potential the reference circuit, stage (D), may not have completely eliminated. Stage C can include an active low-pass filter by using a capacitor in the amplifier feedback loop. This amplifier is can be non-linear (logarithmic) by way of including the diodes in the feedback path to preferentially pass the positive signals (thereby reducing noise). Including a non-linear amplifier in stage (C) can provide a dynamic range of the device by making the gain nonlinear. As a result, larger signals will be filtered slightly more than smaller signals due to the nonlinear resistance of the diodes, and single “spikes” in the signal will not as easily saturate the amplifier. Stage C can include another passive RC high-pass filter (the last capacitor C3 on the output of stage C along with R4) to ensure that no DC signals are present. The amplification provided by the processing circuit 160 can come in three stages. For example, stage (A) can provide a fixed gain of about 13.5, amplifying the difference between the voltage of the two input sensor 200; stage (B) can provide a gain of about 200-1000(optionally controlled by a selector switch); and stage (C) can provide a gain of up to about 5, with the caveat that the amplifier also includes an active low-pass and logarithmic filter. It is contemplated that the signal processing circuit 160 can provide an overall amplification factor of about 10,000 to about 75,000.

As described above, the processor 120 includes a selector switch (not shown) for changing an amplification factor of the signal processing circuit 160. The selector switch can enable the operator of the biofeedback device 100 to customize the size of the signal based on the electrical signals received sensor 200 worn by the user (which varies in magnitude from person to person). For example, the user may wish to change (e.g., increase) the overall processing circuit 160 amplification when measuring between EMG and EKG signals because EKG signals tend to be smaller than EMG signals. An example selector switch can change the amplification factor of an amplifier included in the signal processing circuit 160 by changing the value of resistance connected to the gain stage of the amplifier. For example, the selector switch can be used to physically change which resistor the amplifier is connected to in the gain stage of the amplifier. In an example signal processing circuit 160, the selector switch can be a manual switch that when operated disconnects one resistor and connects another of a different value in its place to alter the circuit amplification. In another example, the selector switch is not a physical switch operated by the user, but rather a digitally-controlled switch or potentiometer. The selector switch can be (provided in section B) can be adjusted to change the amplification factor to at least one of a plurality of pre-set amplification factor values. For example, FIGS. 6C and 6D provide an example signal processing circuit 160 including a selector switch included stage (B). As illustrated in FIGS. 6C and 6D, the signal processing circuit 160 also include an electrode cable shield at the sensor 200 which provides a signal to the reference circuit, stage (D). The pre-set amplification factor value can be selected based on the strength of the signal received from the sensor 200, the lower the signal strength the greater the amplification factor value In an example processing circuit 160, the pre-set amplification factors include an amplification of 13,500, 34,000, and/or 67,500.

In use, the biofeedback device 100 receives an input signal at the processor 120 from the sensor 200 coupled to a user's skin. As provided above, the input signal can include an electrocardiogram (EKG) signal and/or electromyogram (EMG) signal. The signal from the sensor 200 is processing at the signal processing circuit 160 such that processing the signal includes applying an amplification and a filter to the input signal. As described above with respect to FIGS. 6A and 6B, applying an amplification and a filter to the signal includes applying an initial amplification (A), applying a second amplification and an initial filtering (B), and applying a final amplification and final filtering (C).

Processing the signal can also include operating a selector switch to change the amplification factor of the signal processing circuit. For example, the user may wish to change the amplification factor based on user's individual characteristics (e.g., type and placement of sensor 200, user's fat content, sweat or other conductive material present on the user's skin, and the size of the muscle group being measured, etc.).

The processing signal is then transmitted to the control unit 180. The control unit 180 processes the signal to create an output signal that is then provided to the external device 300. The output signal includes instructions to the external device 300 for controlling at least one function of the external device 300. Example instructions include: providing a visual display representing the electrical activity of the corresponding skeletal/cardiac muscle contractions (e.g., visual display of the user's instantaneous or average heart-rate); providing and audible sound/message to the user; operating a light source; controlling a motorized device (e.g., operating a robotic device, operating a motorized vehicle, operating a prosthetic limb, operating a haptic device, operating a remote control, operating a radio transmitter. For example, the biofeedback device 100 can be used as a miniature, mobile, heart monitor. Thereby aiding cardiologists and physical therapists in providing treatment to their patients due to their added ability of monitoring their muscle activity when they are not at the doctor's office.

The processor 120 and/or control unit 180 may have additional features/functionality. For example, processor 120 and/or control unit 180 may include additional storage such as removable storage and non-removable storage including, but not limited to, magnetic or optical disks or tapes. Processor 120 and/or control unit 180 may also contain network connection(s) that allow the biofeedback device 100 to communicate with other devices. Processor 120 and/or control unit 180 may also have input device(s) such as a keyboard, mouse, touch screen, etc. Output device(s) such as a display, speakers, printer, etc. may also be included.

The processor 120 and/or control unit 180 may be configured to execute program code encoded in tangible, computer-readable media. Computer-readable media refers to any media that is capable of providing data that causes the processor 120 and/or control unit 180 (i.e., a machine) to operate in a particular fashion. Various computer-readable media may be utilized to provide instructions to the processor 120 and/or control unit 180 for execution. Common forms of computer-readable media include, for example, magnetic media, optical media, physical media, memory chips or cartridges, a carrier wave, or any other medium from which a computer can read. Example computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processor 120 and/or control unit 180 may execute program code stored in the system memory 140 (and/or system memory 182). For example, the bus may carry data to the system memory 140 (and/or system memory 180), from which the processor 120 and/or control unit 180 receives and executes instructions. The data received by the system memory 140 (and/or system memory 182) may optionally be stored on the removable storage or the non-removable storage before or after execution by the processor 120 and/or control unit 180.

It should be understood that the various techniques described herein may be implemented in connection with hardware or software or, where appropriate, with a combination thereof Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

While the foregoing description and drawings represent the preferred embodiment of the present invention, it will be understood that various additions, modifications, combinations and/or substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. In addition, features described herein may be used singularly or in combination with other features. The presently disclosed embodiments are, therefore, to be considered in all respects as illustrative and not restrictive, the scope of the invention being indicated by the appended claims and not limited to the foregoing description.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention, as defined by the following claims.

What is claimed is:

1. A biofeedback device for processing an electrical signal generated by with the contraction of one or more muscles, the device comprising:
a processor configured to for electrical communication with a sensor worn by a user, the processor including:
a signal processing circuit for processing at least at least one of an electrocardiogram (EKG) signal and an electromyogram (EMG) signal received from the sensor;
a selector switch for changing an amplification factor of the signal processing circuit;
a microcontroller for receiving the processed signal from the processor, the microcontroller providing an output signal to an external device,
wherein the output signal provides instructions for controlling at least one function of the external device.

2. The device of claim 1, wherein the signal processing circuit provides:
an initial amplification;
a second amplification and initial filtering; and
a final amplification and a final filtering.

3. The device of claim 1, wherein the signal processing circuit includes a reference potential.

4. The device of claim 1, wherein the signal processing circuit provides an overall amplification factor of about 7,000 to about 10,000.

5. The device of claim 1, wherein selector switch can be adjusted to change the amplification factor to at least one of a plurality of pre-set amplification factor values.

6. The device of claim 5, wherein the pre-set amplification factor value is selected based on a signal strength of the signal received from the sensor.

7. The device of claim 1 wherein the processor receives both an EKG signal and an EMG signal from a plurality of sensors.

8. The device of claim 1, wherein the processor is electrically coupled to the sensor via at least one of a wire connection and a wireless connection.

9. The device of claim 1, wherein the output signal of the microcontroller provides instructions for controlling at least one pre-programmed function of the external device.

10. The device of claim 1, wherein the output signal is provided to the external device when the signal received from the sensor reaches a threshold.

11. The device of claim 1, wherein the microcontroller is a single-board microcontroller.

12. The device of claim 1, wherein the external device is a visual display unit.

13. The device of claim 1, wherein the external device is a motorized device.

14. The device of claim 13, wherein the motorized device is at least one of a light source, an audio source, a haptic device, a prosthetic limb, a device for stimulating muscle, a motorized vehicle, a remote control, a radio transmitter.

15. The device of claim 1, including the sensor, wherein the sensor includes an electrode for receiving an electrical signal from an area of skin proximate to the sensor when worn by the user.

16. The device of claim 15, wherein the signal provided by the sensor to the processor has a voltage of about 1 mV.

17. The device of claim 1, wherein the device includes a plurality of sensors and the processor is in electrical communication with each of the plurality of sensors.

18. The device of claim 17, wherein at least one of the plurality of sensors receives an EKG signal from the user and an other one of the plurality of sensors receives an EMG signal from the user.

19. A method of using a biofeedback device for directing the control of an external device, the method comprising:
receiving an input signal at a processor from a sensor coupled to a user's skin, the input signal including at least one of an electrocardiogram (EKG) signal and an electromyogram (EMG) signal;
processing the input signal at a signal processing circuit included in the device, processing the signal including applying an amplification and a filter to the input signal;
receiving the processing signal at a controller and providing an output signal to the external device based on the processed signal, the output signal including instructions to the external device for controlling at least one function of the external device.

20. The method of claim 19, wherein applying an amplification and a filter to the signal includes:
applying an initial amplification;
applying a second amplification and an initial filtering; and
applying a final amplification and final filtering.
